(19) United States
(12) Patent Application Publication
(10) Pub. No.: US 2026/0027639 A1
(43) Pub. Date: Jan. 29, 2026

(54) PRINTING HEAD, WIRE FEEDER SYSTEM, AND MOBILE INNOVATIVE WIRE-ARC ADDITIVE MANUFACTURING (MOBILE i-WAAM) APPARATUS

(71) Applicant: DREAMWELDTECH LIMITED, Windsor (GB)

(72) Inventors: Van Anh Nguyen, Yen Son District (VN); Dilen Damian, Windsor (GB); Van Ha Nguyen, Windsor (GB)

(21) Appl. No.: 18/977,775

(22) Filed: Dec. 11, 2024

(30) Foreign Application Priority Data
Jul. 29, 2024 (VN) 1-2024-05648
Jul. 29, 2024 (VN) 1-2024-05649

(51) Int. Cl. B23K 9/04; B23K 9/12; B23K 9/167; B23K 9/32; B23K 103/00; B33Y 30/00; B33Y 40/00

(52) U.S. Cl. CPC B23K 9/042; B23K 9/12; B23K 9/167; B23K 9/321; B33Y 30/00; B33Y 40/00; B23K 2103/50

(57) ABSTRACT

A metal 3D printing apparatus and methods using tiny metal wires as the printing material, designed to be compact and portable, with an innovative printing head and metal wire feeder system are provided. The printing head includes a non-consumable tungsten electrode encased in a protective tube made of copper or copper alloy, a cylindrical ceramic protective gas cap surrounding the protective tube and separated from the protective tube by a gap between them, and two layers of protective gas. The novel metal wire feeder system may feed tiny wires efficiently and smoothly at high speed with precise positioning, utilizing sensor and motor feedback control to manage the droplet transfer mechanism on the melt pool surface. During the printing process, the product may be printed in a printing chamber defined by a sealed enclosure filled with inert gas, which helps achieve high-quality printing.

### CROSS-REFERENCE TO RELATED APPLICATIONS

This application claims the benefit of priority from Vietnam Application No. 1-2024-05648, entitled “Printing Head and Metal 3D Printing Apparatus”, filed Jul. 29, 2024, and Vietnam Application No. 1-2024-05649, entitled “Wire Feeder System and Metal 3D Printing Apparatus”, filed Jul. 29, 2024, which are incorporated herein by reference in their entirety.

### TECHNICAL FIELD

This disclosure relates to an apparatus and methods for producing three-dimensional (3D) objects. More particularly, it relates to an apparatus (including a printing head, a wire feeder system, and a metal 3D printing apparatus) and methods for producing three-dimensional (3D) objects of metal materials by additive manufacturing.

### BACKGROUND

Metal 3D printing (metal additive manufacturing) is a process that melts layer by layer of metal material to build up 3D objects (parts). The number of parts/components produced by 3D printing technology is rapidly increasing, ranging from very small components in medical devices and Micro-Electrical Systems (MEMS) to large and very large parts in aerospace, transportation, and shipbuilding industries, etc. Current metal 3D printing includes metal 3D printing using metal powder and metal 3D printing using metal wire. There has been a growing need for improving metal 3D printing.

The description set forth in the background section should not be assumed to be prior art merely because it is set forth in the background section. The background section may describe aspects or embodiments of the present disclosure.

### SUMMARY

Disclosed herein are embodiments of apparatus systems and methods for producing three-dimensional (3D) objects of metal materials by additive manufacturing. The embodiments may be applicable in various fields such as healthcare, prototyping, automotive, aerospace, etc. The disclosure may also be to a mobile innovate-Wire Arc Additive Manufacturing (mobile i-WAAM) apparatus for achieving high surface accuracy (e.g., less waviness) and low thermal bending when creating thin or ultra-thin walls for 3D objects at the microscale wall thickness of less than 1 mm. This also prevents post-processing from removing unnecessary materials to make the final products and eliminates the residual stress of manufacturing small features at thin and ultra-thin wall thickness.

In some embodiments, the disclosure may include a printing head for printing three-dimensional (3D) objects of metal materials, the printing head may comprise: a non-consumable tungsten electrode encased in a protective tube; a cylindrical ceramic protective gas cap surrounding the protective tube and separated from the protective tube by a gap; and a dual-layer inert gas supply, wherein: the protective tube includes perforations along its body, and the printing head has two layers of protective gas, wherein: an outer protective gas flows through the gap between a cylindrical ceramic protective gas cap and the protective tube, and an inner protective gas flows at high speed through the perforations along the body of the protective tube.

In some embodiments, the disclosure may include a metal 3D Wire Arc Additive Manufacturing (WAAM) printing apparatus comprising the printing head as described above.

In some embodiments, the disclosure may include a metal wire feeder system for printing, comprising: a wire spool assembly and a wire feeder box assembly, wherein: the wire spool assembly includes a wire spool on which a metal wire is wound and a first motor configured to unwind or rewind the metal wire from the wire spool. The first motor is fixed at the center of the wire spool. The metal wire is directed through a guide tube to the wire feeder box assembly, the wire feeder box assembly includes a second motor and a wire feeder box, wherein: the wire feeder box includes therein a drive roller and a driven roller configured to press the metal wire between them and to pull the wire forward, a pressure adjustment mechanism configured to adjust a pressure between the drive roller and the driven roller, a wire feeding tube passes through a wall of the wire feeder box to guide the metal wire out of the wire feeder box towards a melt pool, the second motor configured to assist in pulling the metal wire by controlling the drive roller, the drive roller has very small V-shaped grooves on its surfaces, and the first motor and the second motor operate in synchronization.

In some embodiments, the metal wire feeder system may further comprise a wire feeding nozzle attached to an exit end of the wire feeding tube, wherein an inner diameter of the wire feeding nozzle is 10% to 20% larger than a diameter of the metal wire, and the distance from the tip of wire feeding nozzle to the melt pool surface is less than 3 mm.

In some embodiments, the metal wire feeder system may further comprise a controller for adjusting a pulling force of the metal wire, creating appropriate wire tension during a wire feeding process for printing.

In some embodiments, the metal wire supplied for metal 3D printing apparatus (WAAM) may be a tiny metal wire with a diameter from 0.1 to 0.6 mm.

In some embodiments, the wire feeder box assembly of the wire feeder system may be positioned close to the melt pool surface with the distance from the contact point of drive and driven rollers to the melt pool surface is less than 10 cm.

In some embodiments, the WAAM printing apparatus includes a sealed enclosure defining a printing chamber; and during a printing process, the printing chamber is filled with an inert gas environment, with the printing head, wire feeder system, and printed product contained within the printing chamber.

Other features and advantages of the present disclosure will be or will become apparent to one with skill in the art upon examination of the following figures and detailed description, which illustrate, by way of examples, the principles of the present invention.

In some embodiments, the disclosure may include a metal 3D Wire Arc Additive Manufacturing (WAAM) printing apparatus comprising the wire feeder system as described above.

In some embodiments, the disclosure may include the metal 3D Wire Arc Additive Manufacturing (WAAM) printing apparatus as described above, wherein the WAAM printing apparatus includes a sealed enclosure defining a printing chamber; and during a printing process, the printing chamber is filled with an inert gas environment, with the printing head, wire feeder system, and printed product contained within the printing chamber.

### BRIEF DESCRIPTION OF THE DRAWINGS

FIG. 1 shows an exemplary schematic cross-sectional view from the front of a WAAM apparatus according to some embodiments.

FIG. 2 shows an exemplary schematic cross-sectional view from the rear of a WAAM apparatus according to some embodiments.

FIG. 3A and FIG. 3B show an example of printing a cylindrical shape according to some embodiments.

FIG. 4 shows an exemplary movement of a moving table assembly according to some embodiments.

FIG. 5 shows an exemplary top cross-sectional view detailing a movement of a printing head assembly according to some embodiments.

FIG. 6 shows an exemplary schematic diagram of a cross-sectional view of a wire feeder box assembly, according to some embodiments.

FIGS. 7A and 7B show exemplary cross-sectional views from the side and bottom of a printing head, illustrating the protective gas at the printing head, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure includes apparatus, systems and methods for producing three-dimensional (3D) objects. In some embodiments, the disclosure may include a apparatus (including a printing head, a wire feeder system, and a metal 3D printing apparatus) and methods for producing three-dimensional (3D) objects of metal materials by additive manufacturing. Embodiments of the disclosure may be applicable in various fields such as healthcare, prototyping, automotive, aerospace, etc. In some embodiments, the disclosure may include a mobile innovate-Wire Arc Additive Manufacturing (mobile i-WAAM) apparatus for achieving high surface accuracy (e.g., less waviness) and low thermal bending when creating thin or ultra-thin walls for 3D objects at the microscale wall thickness of less than 1 mm. This may also prevents post-processing from removing unnecessary materials to make the final products and eliminates the residual stress of manufacturing small features at thin and ultra-thin wall thickness.

In metal 3D printing using metal powder, the heat source from a laser beam or electron beam, typically with very high focus and rapid movement, helps reduce the deformation of the printed products. Moreover, the very small size of the metal powder particles, around 30-100 micrometers, when combined with a focused laser or electron beam, creates a very small melt pool. Therefore, metal 3D printing using metal powder usually results in high surface accuracy and can print very small objects (small features) with thin and ultra-thin walls. Currently, metal 3D printing using metal powder mainly prints small and complex components with high surface accuracy for medical applications (such as implants, bones, stents) or high-tech fields like aerospace and electronic devices.

Although current metal 3D printing using metal powder may produce good surface accuracy, it has drawbacks such as low metal deposition rate, limited dimension of printed components (because it is printed in sealed chambers), and high cost. This technology also has other disadvantages, such as it is easy to produce products with defects like slag inclusion or gas porosity due to using very small and difficult-to-control laser or electron beams to achieve full fusion between printed layers.

For metal 3D printing using metal wire (wire-arc additive manufacturing-WAAM), the high-energy plasma arc column emitted from the printing head can melt an area on the substrate surface or the previous printed layer to form the melt pool. The wire feeder kit fed and adjusted the metal wire to be melted and transferred into the melt pool. In other WAAM processes, the wire with a diameter of about 0.8-3.6 mm is fed from the wire feeder kit, melted by the arc plasma of the printing head, and then dropped into the melt pool. After that, the melt pool is cooled and solidified to form a metal deposition layer on the substrate or the surface of the previously printed layer.

Other WAAM processes utilize large-diameter metal wires with a high metal deposition rate; however, the printed product has low surface accuracy and relatively high equipment investing costs due to the low accuracy and instability of the wire feeder system. Other WAAM processes typically use a very high current (up to several hundred amperes) to create a high-intensity arc to melt the large wires and form deposition. This leads to difficulty controlling the input heat, often causing overheating and creating many defects such as large thermal deformation, melt pool sagging, and melt pool oscillation (due to the big droplet), resulting in very low surface accuracy. Therefore, other WAAM usually produces initial printed products with low surface accuracy (e.g., high surface waviness), requiring intensive post-processing machining and surface treatment. This process is time-consuming and costly. Additionally, in other WAAM processes, typical defects like large deformation and residual stress due to the high heat input from the printing head and the defocus arc column affect the quality of the printed product and make it very difficult to process after printing. Due to the above characteristics, other WAAM technologies are only used to fabricate large parts with thick printed walls (several millimeters to dozens of millimeters), low complexity, primarily used to produce components such as body of rockets, frames of airplanes, missile fuselages, and other large parts in the aerospace industry where the walls are very thick, and high surface accuracy of printed parts/components is not required.

The present disclosure may improve and overcome the drawbacks of other metal 3D printing technologies and apparatus. In some embodiments, the present disclosure may include novel/breakthrough technologies and apparatuses for metal 3D printing that may leverage and/or maintain the advantages of both metal 3D printing technologies (powder and WAAM) while minimizing their drawbacks. A goal of the present disclosure may include an innovative WAAM technology and mobile WAAM apparatus (mobile i-WAAM) that may achieve high surface accuracy close to metal 3D printing technology/apparatus using metal powder in fabricating small and very small features with thin and ultra-thin walls with high deposition rates. Additionally, the mobile i-WAAM apparatus may be compact, flexible, and easy to move, suitable for use in various locations, from offices, laboratories, and classrooms of universities or institutions, R&D centers and factories of companies, etc.

First, the printing head's magnitude, characteristics, and energy density may determine the size of the melt pool, printing stability, and cooling rate of printed parts. Furthermore, controlling the behavior and droplet transfer mechanism of metal wire in WAAM processes may be crucial in adjusting the melt pool size and oscillation. Typically, if the size of the droplet is too large when it falls into the melt pool, it may create significant instability and significant oscillation of the melt pool. When the melt pool solidifies/crystallizes, it may create wavy and rough surfaces on the printed parts. Therefore, to achieve high surface accuracy of the printed products, controlling the droplet size to be as small and stable as possible and the accuracy of wire location may be essential. At the same time, the energy heat source from the printing head may be highly concentrated to create a tiny melt pool to achieve the smallest deposition layer width for printing thin and ultra-thin walls. Therefore, in some embodiments, the present disclosure may include an innovate and mobile WAAM apparatus (mobile i-WAAM) based on these analyses, enabling the creation of thin and ultra-thin printed walls with the desired surface accuracy.

In WAAM processes, the arc emitted from the printing head is the energy source that creates the melt pool. Also, controlling the behavior and mechanism of droplet transfer can be achieved by developing a new wire feeder system for using very small-sized/tiny metal wires to create tiny metal droplets, minimizing issues of instability and oscillation of the melt pool and leading to unstable surface quality. Thus, in some embodiments, another goal of the present disclosure may include developing a printing head emitting a high energy density arc (narrow and compressing arc) and using tiny metal wires to produce tiny metal droplets and small melt pools as the determining factors for the surface quality of the printed product. The concentrated energy from the high and compressing plasma arc column and tiny droplet transfer from tiny metal wires may help better control the printing process, thereby fine-tuning the printed product shape at higher surface accuracy and much thinner walls than other WAAM processes.

In some embodiments, the present disclosure may aim to achieve high control over the factors affecting the quality of WAAM processes mentioned above and improve the overall capabilities of WAAM to create small features/parts. The printing current (amperes) may be set to a very low value (from a few amperes to a few dozen amperes) compared to one hundred to several hundred amperes of current in other WAAM apparatus. The wire feeder system of the present disclosure may feed metal wires with diameters much smaller than those currently used in other WAAM systems. At the same time, the printing head of the present disclosure may form a compressing arc column to form a highly converging and stable arc column. The combination of these factors may produce small-sized, thin-walled (micron-sized) 3D objects with high surface accuracy and high deposition rate for manufacturing components in the medical field, such as implants, bones, teeth, or small parts in the aerospace industry, electronic devices, etc.

In some embodiments, the present disclosure may include a novel and new type of WAAM apparatus and methods using tiny metal wires. The printing head and the metal wire feeder system of the present disclosure may achieve superior advantages by using tiny wires (e.g., 0.1-0.6 mm diameter) compared to other WAAM apparatuses that use regular metal wires (0.8-3.6 mm diameter metal wires).

In some embodiments, the printing head of the present disclosure may include a novel design with a much smaller size and more compact than the printing heads of other WAAM apparatus. It may include a non-consumable tungsten electrode contained within a protective tube and a two-layer inert gas orifice (inner gas, e.g., argon, helium, or mixed gas). The printing head of the present disclosure may create compressing and narrowing arc columns and maintain arc stability better than other printing heads (e.g., printing heads for other WAAM processes), especially at low printing currents (around ten and several dozen amperes). The tungsten electrode of the printing head may be cooled by two layers of protective gas simultaneously: an outer protective gas layer and an inner protective gas layer. In some embodiments, the outer protective gas layer may be a shielding gas, and the inner protective gas layer may have a primary function of cooling the tungsten electrode, compressing the arc plasma column, and reducing the temperature of the tungsten electrode under a high-speed gas flow surrounding the tungsten electrode. This may help maintain the low melt pool surface temperature to prevent evaporation. As a result, the novel printing head of the present disclosure may effectively control and significantly reduce the evaporation of the melting metal from the melt pool to minimize its adhesion to the printing head (tungsten electrode), ensuring high stability over the melt pool and arc plasma at high temperatures, thus maintaining stable, long-term, and high-performance printing. Also, this printing head may push the evaporated metals from the melt pool far away and avoid attaching them to the tungsten electrode tip to maintain their lifetime. The inner protective gas layer may also compress the arc column, forming an arc column with high focus. This may create a tiny melt pool and focus the heat input to increase the energy density. This may help to easily melt metal wires and maintain printing stability at a low printing current and short arc length of less than 1 mm (distance from tungsten tip to melt pool surface).

In some embodiments, the printing apparatus of the present disclosure may also have a specific printing power source. This power source may finely control the pulse frequency of the printing current, with the frequency changing from, e.g., 1-120 Hz. This may benefit as the energy supplied per unit of time (heat input) may be reduced substantially, thereby accurately controlling the output arc plasma energy and forming the tiny melt pool. This may be especially important for printing ultra-thin walls at the microscale thickness.

The metal wire feeder system of the present disclosure may include further significant importance. In some embodiments, it may be much smaller and more compact than that of other WAAM apparatus. It may be designed to control the pushing and pulling of a tiny wire (e.g., 0.1-0.6 mm diameter) at a very precise degree. In some embodiments, the metal wire feeder system may include two main parts: a wire spool and a wire feeder box. The wire spool may include key components such as the spool and the first motor to pull the tiny metal wire out of the spool. The tiny metal wire pulled out from the spool may pass through a guiding tube to be directed to the wire feeder box. The wire feeder box may comprise key components such as a drive (active) roller, a driven (passive) roller, a second motor to pull the wire, a pressure adjustment component, and a wire feeding tube. The tiny metal wire entering the wire feeder box may be clamped between the drive and driven rollers for pulling. A lever may serve as the pressure adjustment component, positioned inside the wire feeder box, to adjust the pressure between the two rollers. The two motors of the metal wire feeder system may operate synchronously to pull the wire, preventing/avoiding wire breakage and minimizing wire twisting and tangling at the location between the drive roller and wire feeding tube. The drive or driven rollers may have very fine V-shaped grooves on their surfaces to enhance friction and pull the wire. The wire feeding tube (made of copper or copper alloy) may extend through the wire feeder box wall, with a part inside the box and part extending out towards the location between the printing head and the melt pool surface. At the tip of the wire feeding tube is attached a wire feeding nozzle. In this case, the wire feeding nozzle may be extremely close to the melt pool surface, e.g., at less than 1 mm from the melt pool surface.

In some embodiments, the wire feeder box assembly may be positioned very close to the melt pool surface but the wire spool may be positioned far from the melt pool surface. The distance between the contact point of the drive and driven rollers of this wire feeder system to the melt pool surface may be less than 10 cm. Meanwhile, the first motor may be fixed together with the wire spool and far from the melt pool surface (this is distinguishable from the wire feeder system configuration in other WAAM internals, in which they have only one motor (similar to the second motor in the mobile i-WAAM apparatus) to control the drive roller. Also, they do not have the first motor to fix and control with wire spool as the mobile i-WAAM apparatus does. They also do not have a pair of two drive and driven rollers that are fixed in a small and compact wire feeder system extremely close to the melt pool surface as the mobile i-WAAM apparatus does. The distance from the contact point of drive and driven rollers in other WAAM apparatus to the melt pool surface is about 50 cm or more, on the other hand, this distance is less than 10 cm in the mobile i-WAAM apparatus of the present disclosure). The end of the wire feeding tube may have a nozzle (wire feeding nozzle) with a hole that may be 10% to 20% larger than the diameter of the fed metal wire. The tip of the wire feeding nozzle may be positioned close to the melt pool surface (less than 3 mm from the melt pool surface). After being pushed out of the wire feeding tube, these features may ensure that the position of the metal wire tip may be rightly controlled on the melt pool surface during printing. In terms of positioning, compared to other WAAM apparatus, the wire feeder box of the present disclosure may be placed very close, or extremely close, to the melt pool surface to prevent the tiny metal wire with a very small diameter from becoming tangled and twisted at the contact point of the drive roller and wire feeding tube.

In some embodiments, the present disclosure may include a printing platform/table, where the metal substrate may be placed, which may rotate 360 degrees to ensure that the relative position of the printing head and metal wire may be maintained in the same order and position.

In some embodiments, the main components of the mobile i-WAAM apparatus may be enclosed in a sealed chamber during printing, and the printing operation may occur within this chamber. The inside of the sealed chamber may be filled with inert gas (e.g., argon, helium, or mixed gas), which may serve as a protective gas together with shielding gas from the printing head. This may maintain an uncontaminated environment during printing, ensuring that the printing may achieve the highest quality, especially when using sensitive metals such as aluminum or titanium. This may be a significant improvement of the WAAM apparatus, compared to other WAAM apparatus. The sealed chamber may also ensure the safety of observers and operators during the operation of the apparatus.

Furthermore, in some embodiments, all components of the mobile i-WAAM apparatus may be constructed in a closed system together with a shielding gas cylinder, forming a compact, flexible apparatus that may be moved on wheels. The present disclosure may include a complete protective gas supply system without needing external shielding gas, making it usable anywhere without disturbing extending gas pipes and other related equipment and components. This is a novel feature does not present in other metal AM apparatus (including both powder-based and wire-based metal 3D printing apparatus), as they are typically large, bulky systems with separate gas supply mechanisms from gas centers of workshops, factories, or laboratories, mainly suited for fixed installation in production facilities of companies or laboratories of institutions.

On the other hand, due to this mobile i-WAAM apparatus's compactness and flexibility compared to other WAAM apparatus, the overall cost of the apparatus may be significantly lower than that of other metal 3D apparatus.

### Exemplary Achievements of the Present Disclosure

The WAAM apparatus, in some embodiments, may overcome the inherent limitations of other WAAM apparatus in the production process. The WAAM apparatus, in some embodiments, may be compact, portable, and may operate with much greater flexibility than other WAAM apparatus. It may print much smaller and thinner metal objects (e.g., the wall thickness at ⅕ millimeter) compared to other WAAM apparatus with higher surface accuracy, less thermal distortion/residual stress, and significantly lower investing costs. Meanwhile, compared to metal 3D apparatus using metal powder, the apparatus of the present disclosure may have a higher deposition rate due to the use of bigger wire and less investing cost due to compact, simple, and flexible apparatus, allowing it to become the world's first flexible and compact WAAM apparatus.

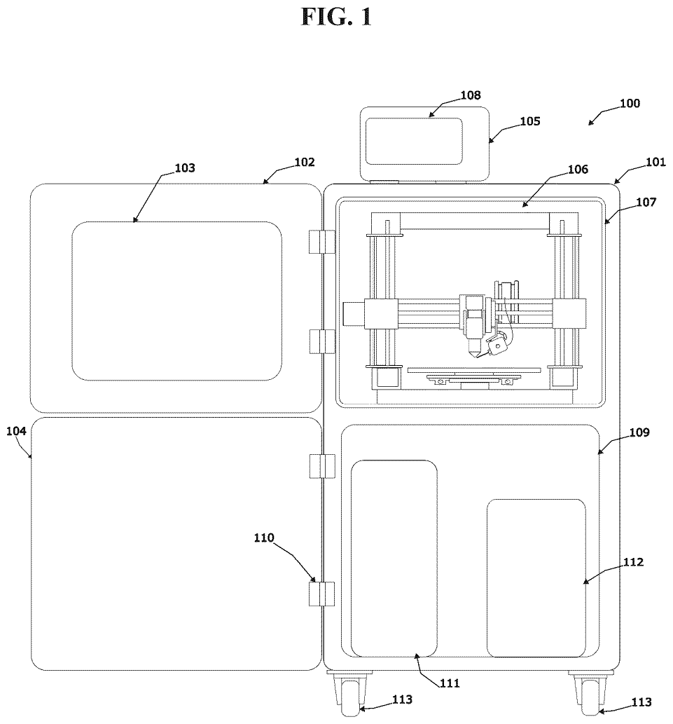

FIG. 1 shows an exemplary schematic cross-sectional view from the front of the WAAM apparatus 100 according to some embodiments, showing the main components of the apparatus constructed in a sealed chamber with electronic components and a printing power source placed in a lower compartment.

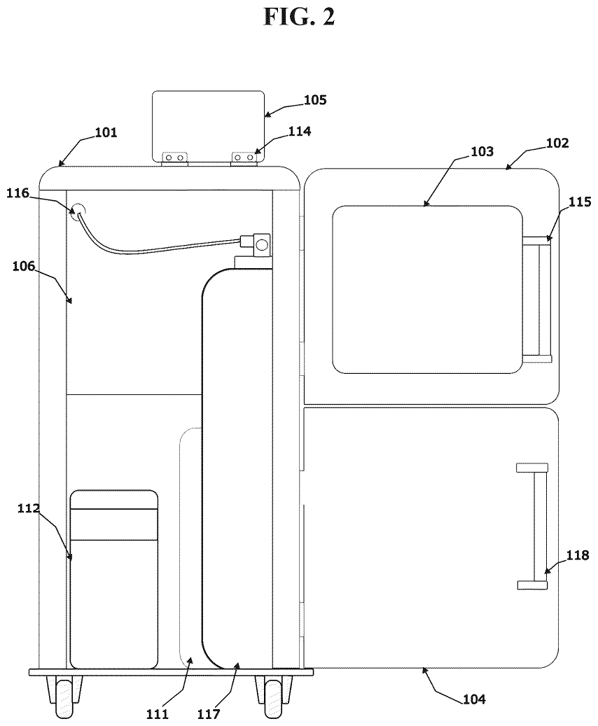

FIG. 2 shows an exemplary schematic cross-sectional view from the rear of WAAM apparatus 100, showing the protective gas supply system (shielding gas cylinder) according to some embodiments.

In some embodiments, the WAAM apparatus 100 may integrate a novel printing head with a wire feeder system, a tiny metal wire, and a portable shielding gas cylinder constructed in a sealed chamber. This manufacturing method may produce metal 3D objects that can be used directly without requiring additional machining or post-processing steps. Compared to other WAAM and other manufacturing techniques, this may significantly reduce material consumption and the time needed from conception to production.

The metal 3D printing process using the WAAM apparatus 100, in some embodiments, may include the following steps:
1. Determine the position where the printing head needs to start.
2. Determine the direction and orbital of movement for the printing head and printing table/build platform.
3. Create an electric arc between the substrate and the printing head electrode, melting the substrate material to form a molten metal pool (melt pool).
4. Move simultaneously the printing head and build platform (printing table) along the predetermined movement direction and orbital.
5. Feed a tiny metal wire (diameter 0.1-0.6 mm) into the area between the printing head and the melt pool surface. The arc from the printing head melts the wire to drop to the melt pool surface.
6. The melt pool solidifies upon cooling to form a layer on the substrate surface.
7. Repeatedly perform the above steps based on positions determined by the control and printing program to create the final product as a 3D object.

In some embodiments, the WAAM apparatus 100 may operate following the abovementioned steps. Its detailed operation processes are described below with reference to the accompanying drawings.

FIGS. 1 and 2 show the exemplary WAAM apparatus 100, according to some embodiments for manufacturing 3D metal objects. The WAAM apparatus 100 may fabricate sample net-shaped or nearly net-shaped parts for various applications. After printing, the printed parts may need to be separated/cut from the substrate, and then their surfaces may need to be cleaned or light post-processing before use.

In some embodiments, the WAAM apparatus 100 may be compact and portable. Overall, the WAAM apparatus 100 may include the upper and lower compartments, as shown in FIG. 1. The upper compartment may contain the sealed chamber 106. This sealed chamber 106 may contain the main essential parts of the WAAM apparatus 100, including the printing head, metal wire feeder system, build platform (printing table), motors, gantry movement system, etc. The lower compartment 109 box may contain other components, such as the printing power source (printing power supply) 112 and controller (PCB) 111. On the other hand, at the backside of the WAAM apparatus 100, a cylinder containing protective gas 117 may be located. Inert gas (e.g., argon, helium, or a gas mixture) may serve as the protective gas supplied inside the sealed chamber 106 through tube 116, as shown in FIG. 2. The portable WAAM apparatus 100 may be moved by unlocking the mobility wheels 113 located at the bottom of the apparatus frame. Opening doors 102 or 104 may allow access to the upper compartment (sealed chamber 106) or the lower compartment 109. The two doors may be securely attached to the outer frame 101 using two hinges 110 on each door. Handle 115 may be positioned on door 102 of sealed chamber 106 with the support of electromagnetics. The door 104 of the lower compartment may be opened using handle 118.

The display panel (HDMI panel) 105, located at the top of the outer frame 101, may set printing parameters and observe the melt pool and arc plasma through processing cameras at the top corner inside sealed chamber 106. It may display information on screen 108. The display panel 105 may have a touch interface on screen 108, which may help select operations and manually control the movement of the parts in the sealed chamber 106.

The sealed chamber 106 may include a glass window 103 coated with a polarizing film to prevent the brightness radiation of arc plasma and ensure safety when observing the process directly through the glass. The WAAM apparatus 100 may include a process camera inside the sealed chamber 106, allowing the operator/worker to observe the printing process via the display panel 105. This process camera may help monitor the printing process on the display panel 105 and may connect to an external computer to manage the printing program.

The sealed chamber 106 may be essential for printing sensitive materials like titanium or aluminum because these materials highly react to oxygen to form oxidation and loss of material integrity. The sealed chamber 106 may maintain an inert gas environment at low oxidation (low parts per million (ppm)) by filling it with inert gas from the protective gas supply 117 into the chamber. When the sealed chamber door 102 is tightly closed, the rubber liner 107 at the junction between the door and the frame may prevent the inner gas leakage. This may ensure a sealed operation environment during the printing process and may ensure the safety of the observer or worker during the operation. This may be a significant difference between the WAAM apparatus 100 and other WAAM apparatus in that WAAM apparatus 100 may protect metal materials prone to oxidation to enhance printed parts' quality and stability.

The arc power supply (printing power source) 112 may control the frequency of printing current, e.g., from 1 Hz to 120 Hz. This may provide the ability to control the pulse time and width of the input power (energy input) per unit of time (heat input). This capability and maintaining the reasonable current level and printing speed may make the heat input finer and superior. This may improve the melting efficiency during the printing process and enhance the capability of printing thin and ultra-thin walls (e.g., less than 1 mm thickness) with high surface precision for this mobility i-WAAM apparatus.

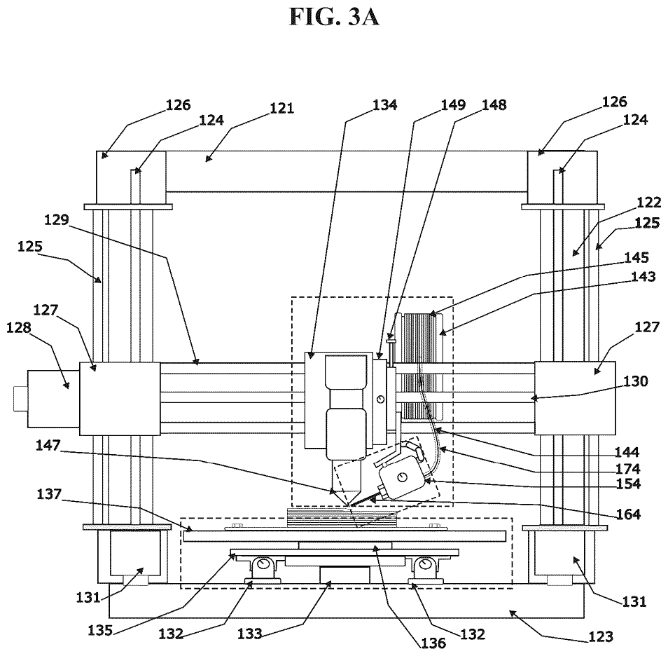

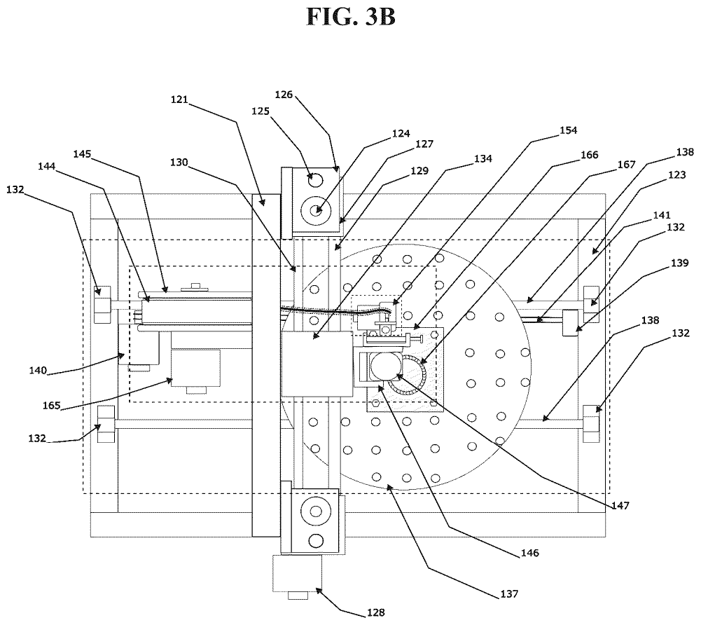

FIG. 3A and FIG. 3B show an example of printing a cylindrical shape 167, placed within the sealed chamber 106 of the WAAM apparatus 100, according to some embodiments. In these embodiments, the printing head assembly 168 may include the main parts: printing head 147, metal wire feeder system consisting of wire feeder box 154, and wire spool 145. These embodiments may also include the movable printing table (build platform) 137 and the frame assembly (holding the printing head and metal wire feeder system) 134 on which the printing process may be performed. This frame assembly 134 may move vertically and horizontally. The metal wire feeder system may be mounted on frame assembly 134 and maintain a constant distance from the printing head 147.

The printing head assembly 168 structure may be supported by aluminum brackets 121, 122, and 123. The main parts of the printing head assembly 168 may be mounted on the aluminum structure. The vertical movement of the frame assembly 134 may be controlled using two lead screws 124 mounted vertically. The rotation of the lead screws 124 may be controlled using stepper motors 131 on each side of the vertical aluminum brackets 122.

The support columns 125 may be mounted vertically along with the lead screws 124. The support columns may reinforce the horizontal support system and prevent wobbling or uneven lifting or lowering during its movement. The lead screws 124, and the slide rails for moving the support columns may be located inside the mounts 127.

The stepper motors 131 and the top supports for the support columns 125 may be supported on both sides using two mounts 126 at the top and bottom on both sides. The mounts may be attached to the vertical supports 122, thus acting as supports for both the lead screws 124 and the support columns 125.

The movement of the printing head assembly 168 may be restricted to the vertical plane, and horizontal movement during the printing process may be achieved by controlling the movement of the printing table/build platform.

The mounting holes may secure substrate plate 166 to the printing table/build platform 137 using bolts or clamps.

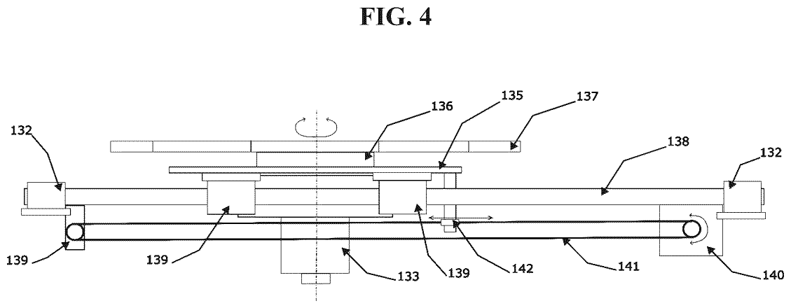

FIG. 4 describes an exemplary movement of the moving table assembly that facilitates horizontal and rotational movement of the printing table 137, according to some embodiments. The printing table 137 may be supported on a rotary table 136 to avoid overloading the motor shaft. The rotary table 136 may be mounted on the horizontal moving plate 135. The rotary table 136 may rotate 360 degrees to rotate the printing table 137 correspondingly. The rotational movement of the rotary table may be controlled by motor 133. The linear horizontal movement of moving plate 135 may be controlled by motor 140 mounted on base support 123. The motor belt may connect to the motor at one end and the rotary bearing 139 at the other, facilitating the linear movement of hinge 142 connected to moving plate 135.

The slide rail 138 may be fixed at both ends 132. It may support the movement of moving plate 135, containing the rotary bearing 139. The rotary bearing 139 may create low-friction movement of the printing table throughout the printing process.

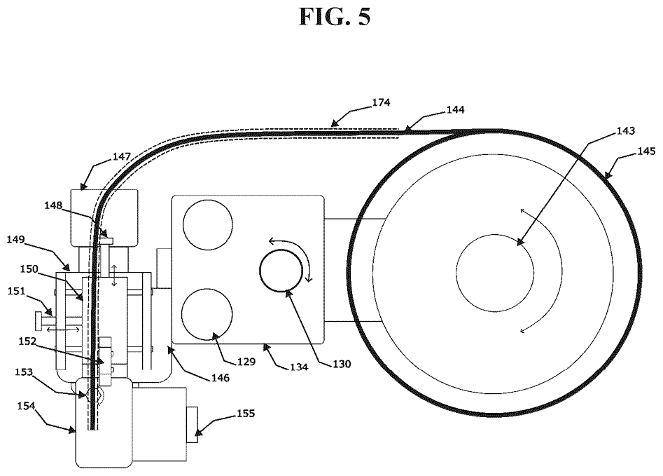

FIG. 5 shows an exemplary top cross-sectional view detailing the movement of the printing head assembly 168, including the main parts: printing head 147, metal wire feeder system consisting of the wire feeder box 154 and wire spool 145, according to some embodiments. The horizontal movement of the support system housing the printing head assembly 168 may be controlled by rotating the lead nut of lead screw 130 housed within the printing head support frame assembly 134. The stability of the movement may be maintained using rotary bearings moving along guide rods 129. The wire spool 145 may be mounted on one side of the housing of the frame assembly 134 and may have a shaft 143 connected to the wire spool control motor 165 (see FIG. 3B) mounted behind the wire spool 145 to control the unwinding and winding of metal wire 144 wound around the wire spool 145. The metal wire 144, after being unwound from the wire spool 145, may pass through the wire guide tube 174 to be guided into the wire feeder box 154 and then delivered to the vicinity of the printing head 147, where it may be melted to combine with the melt pool.

The other end of the housing of the frame assembly 134 may be mounted with the printing head holder 146, and the printing head 147 may be mounted on it. The wire position control device 149 may be mounted next to the printing head holder 146. The wire position control device may be used to precisely control the exit position of the metal wire 144 when it is fed into the area between the arc plasma and melt pool surface during printing. The horizontal movement of the wire tip may be controlled by screw 151, and the vertical position may be controlled by screw 148. The angle of the metal wire 144 relative to the printing head 147 may be adjusted by adjusting screw 153. The angle of the metal wire 144 relative to the printing head 147 may be adjusted in the range of 10 degrees to 30 degrees.

The following section describes some exemplary technical features of the metal wire feeder system and printing head according to some embodiments of the present disclosure.

In some embodiments, the metal wire feeder system may include two main parts: the wire spool assembly and the wire feeder box assembly, which may be arranged on frame assembly 134. Referring to FIG. 5, the wire spool assembly may include the wire spool 145 around which the tiny metal wire 144 may be wound and a motor 165 may be mounted behind the wire spool 145 to control the winding and unwinding of the metal wire from the wire spool 145. The tiny metal wire 144 (with a diameter of, e.g., 0.1-0.6 mm) may be drawn from the wire spool 145 and may pass through a guide tube 174 to be directed to the wire feeder box 154.

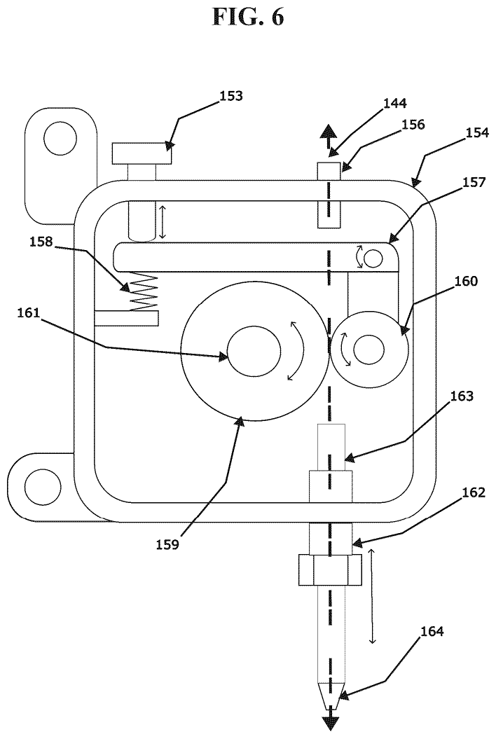

FIG. 6 shows a schematic diagram of a cross-sectional view of the wire feeder box assembly, according to some embodiments. The wire feeder box assembly may include a second motor 155 and a wire feeder box 154. Inside the wire feeder box 154 may include a drive roller 160 and a driven roller 159, with a pressure adjustment mechanism between the two rollers being a lever 157. The wire receiving tube 156 and an adjustment screw 153 may be arranged through the side of the wire feeder box 154 opposite the wire spool 145. The wire feeding tube 163 may be arranged through the side of the wire feeder box 154 opposite the side where the wire receiving tube 156 is located to guide the tiny metal wire 144 close to the printing head 147.

An exemplary operation of the feeding process of metal wire during printing is described in detail here, according to some embodiments. When feeding the metal wire for the metal 3D printing process, motor 165 may control the wire spool 145 to operate in sync with motor 155, which may control the drive roller 160 to pull the tiny metal wire 144. The tiny metal wire 144 may be drawn from the wire spool 145, may pass through the guide tube 174 to be directed through the wire receiving tube 156 at the top (side) of the wire feeder box 154, and enter the wire feeder box 154. The tiny metal wire 144 may be compressed and pulled between the two rollers (the drive roller 160 and the driven roller 159) inside the wire feeder box 154. The drive roller 160 may be manufactured with very small V-shaped grooves on its surfaces to increase friction and stability and to guide the metal wire. The use of two motors (155 and 165) operating synchronously to pull the metal wire in the wire feeder system may be a fundamental difference of this WAAM system compared to other WAAM apparatus that use a single motor to pull the metal wire from the wire spool. Since the metal wire 144 used in the WAAM apparatus 100, according to some embodiments, may be tiny, with a diameter of, e.g., only about 0.1-0.6 mm, using two motors to pull the wire synchronously at two separate positions (the distance between two motors may be very far) may help distribute the tension evenly along the length of the tiny wire, preventing excessive tension at compression points, which may lead to wire breakage during pulling. Furthermore, the motors 155 and 165 may need to operate in parallel, synchronously to simultaneously pull the tiny metal wire 144 to ensure that the wire remains taut and does not sag, preventing tangling or twisting of the wire during the pulling process.

The lever 157 may adjust the pressure between the driven roller 159 and the drive roller 160. The adjustment of the lever to modify the pressure between the two rollers may be done using a spring 158 and an adjustment screw 153 arranged opposite each other on two sides of the lever 157, as shown in FIG. 6. In some embodiments, lowering lever 157 by lowering the adjustment screw 153 may reduce the pressure between the two rollers, and raising lever 157 by raising the adjustment screw 153 may increase the pressure between the two rollers.

The tiny metal wire 144 may be compressed and pulled by the drive roller 160 and the driven roller 159, then pass through the wire feeding tube 163 at the base of the position adjustment screw 162, which may be arranged through the side of the wire feeder box 154 and may protrude outwards. The end of the wire feeding tube 163 may be positioned at the front, close to the printing head 147 in the printing direction. This may ensure that the metal wire 144, after being pushed out, may melt together with the previously printed layer and may be controlled more accurately during the melting wire process. The end at the exit (the end protruding from the wire feeder box 154) of the wire feeding tube 163 may be fitted with a wire feeding nozzle (copper or copper alloy) 164. The tiny metal wire 144 may finally be pushed out through the wire feeding nozzle 164, moving towards the space between the printing head 147 and the melt pool surface to be heated and melted, dripping into the melt pool.

The wire feeding nozzle 164 may have a slightly larger internal diameter than the tiny metal wire 144 diameter. Preferably, the internal diameter of the wire feeding nozzle 164 may be larger by 10% to 20% compared to the diameter of the metal wire 144. This may ensure that the end of the tiny metal wire 144 may fit snugly inside the wire feeding nozzle 164 and may be fully constrained when pushed out. This may ensure that the end of the tiny metal wire 144 may be fixed in the best possible related position when exiting from the wire feeding nozzle 164 so that the molten metal droplets may fall precisely into the melt pool center. Suppose in a situation where the internal diameter of the wire feeding nozzle 164 is too large. In that case, the end of the metal wire exiting from the wire feeding nozzle 164 can move freely, causing molten metal droplets to fall inaccurately into the melt pool (to the sides of the melt pool), leading to reduced accuracy of printed walls.

In addition, other WAAM apparatus use standard metal wire from welding wire (0.8-3.6 mm), and the wire feeder box of welding systems is positioned relatively far from the melt pool surface. Therefore, a very long wire guide tube is needed to bring the metal wire to the melt pool surface. However, according to some embodiments of the present disclosure of the WAAM apparatus 100, the metal wire 144 fed for printing may be tiny. If it travels a long distance from the rollers 159 and 160 to the wire feeding tube 163 and wire feeding nozzle 164 through a long wire feeding tube, it may easily become tangled and twisted inside the wire feeding tube 163 or at the contact point with the drive roller 160 and the driven roller 159 or at the position before entering to the wire feeding nozzle 164. Therefore, the present disclosure includes a solution where the wire feeder box assembly, including the second motor 155, drive roller 160, driven roller 159, and other components described above, may be arranged very close to the melt pool surface with the distance from the contact point of drive and driven rollers to the melt pool surface is less than 10 cm. At the same time, the wire feeding tube 163, according to some embodiments, may be made much shorter compared to the wire feeding tubes of other WAAM apparatus. This may help to regulate the position of the wire better and reduce tangling and twisting, making the feeding of the tiny metal wire 144 proceed smoothly.

Additionally, in-depth research into the operation of the WAAM printing apparatuses has noticed that when the wire end is fed into the melt pool surface, the tiny metal wire 144 can tend to be pushed backward against the feed direction due to electromagnetic forces (interaction of primary printing current and by-pass current (current between printing head and tiny wire)), leading to the wire potentially sagging. Therefore, according to some embodiments of the present disclosure, the metal wire feeder system may also be equipped with a control mechanism to adjust the pulling force of the wire, creating suitable wire tension during metal wire feeding for printing. For example, when detecting signs that the metal wire is being pushed back, causing reduced wire tension and sagging, the wire spool 145 may be controlled to reel in the metal wire, and/or the lever 157 may be adjusted to modify the pressure between the drive roller 160 and the driven roller 159 to create appropriate wire tension by reducing the speed to push wire. The overall movement of the tiny metal wire 144 may be controlled (e.g., reduce the speed to push the wire) with the assistance of computer programs and sensors that may be attached to monitor the sagging or tension of the tiny metal wire 144 during feeding.

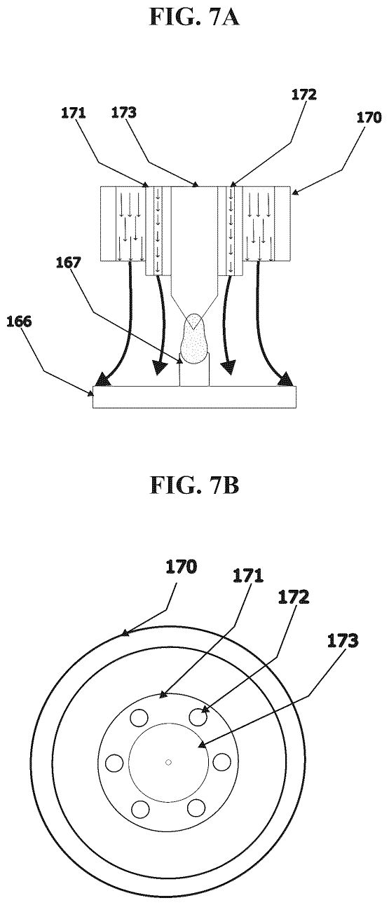

The printing head 147, according to some embodiments, may be capable of better arc plasma column convergence than other printing heads (e.g., printing heads for other WAAM processes). It may also effectively control and significantly reduce the evaporation of the molten metal from the melt pool to minimize its adhesion to the tungsten electrode of the printing head, thereby ensuring a stable, long-lasting, and high-performance printing process. Referring to FIG. 7A, it shows an exemplary cross-section of the printing head, according to some embodiments. The gas in the printing head may include two layers: an outer protective gas layer, e.g., similar to the shielding gas in other WAAM processes, and an inner protective gas layer, which may exit through perforations along the body of a protective tube.

The printing head, according to some embodiments, may include a non-consumable tungsten electrode 173 enclosed in a protective tube 171 (which may be made of copper or copper alloy), a cylindrical ceramic protective gas cap 170 surrounding the protective tube 171 and separated from the protective tube 171 by a gap between them. There may be several small holes along the body of the protective tube 171. The shielding in this novel printing head may include two layers: the inner protective gas layer and the outer protective gas layer. The structure and operation of the two layers of protective gas for the printing head may be as follows: the outer protective gas may flow through the gap between the protective gas cap 170 and the protective tube 171; the inner protective gas may flow at high speed through multiple small through-holes 172 (drilled) along the body of the protective tube 171 as shown in FIG. 7B. In some exemplary embodiments, the protective tube 171 of the printing head 147 may have six through-holes, each with a diameter of approximately 0.3-0.6 mm for the inner protective gas layer to flow through. In this case, the tungsten electrode 173 of the printing head 147 may be cooled by two layers of protective gas simultaneously: the outer and inner protective gas layers. The outer protective gas layer may be the same as the shielding gas in other printing heads, and the inner protective gas layer may be at high speed and pressure. The inner protective gas layer may primarily reduce the tungsten electrode tip temperature, compressing the arc plasma column and significantly reducing the tungsten tip contamination to maintain arc stability. Additionally, because the inner protective gas may flow out at high speed where the arc is emitted, compressing the arc plasma column by the thermal pinch-effect principle, thus concentrating the emitted arc into a stable, convergent column with a narrow morphology. This crucial factor may enable the printing head 147 to create a stable and high energy density arc plasma to form a tiny melt pool during printing, resulting in thin and/or ultra-thin walls at microscale thick with desired surface accuracy.

Therefore, the two layers of protective gas in the printing head 147 not only may help cool the tungsten electrode 173, compress and stabilize the arc column, but also may prevent contamination of the tungsten electrode tip, improving electrode lifespan and protecting the melt pool during printing. This may allow the printing head 147 to maintain a very short arc length of less than 1 mm (distance from the tungsten electrode tip to the melt pool surface).

With the improved printing head 147 as described above, the current during the printing process using the WAAM apparatus 100 of the present disclosure may be set to a very low value (e.g., from a few Amperes to several tens of Amperes) compared to one hundred to several hundreds of Amperes of the current in other WAAM apparatus. In other WAAM apparatus, if the printing current is low, the generated arc will disperse into a broad region with very poor convergence under the low electromagnetic field, thus failing to create an appropriately tiny melt pool for printing thin and ultra-thin walls. This dispersed arc also struggles to melt large-diameter metal wire fed into the melt pool. Therefore, a high current (up to one or several hundred Amperes) is required in other WAAM apparatus to generate an arc with sufficient energy for melting the metal wire. However, with the printing head 147 of the present disclosure, the arc column compression effect of the inner protective gas layer may help maintain good convergence of the arc column, even with a small printing current of only a few Amperes, enabling the creation of a small-sized melt pool as desired and effectively melting the metal wire fed into the melt pool for deposition.

These effects of the two layers of protective gas in the printing head may significantly contribute to achieving high surface accuracy in the WAAM apparatus 100 printing with thin and ultra-thin walls.

In some embodiments, the printing head of the present disclosure may represent a significant improvement over other WAAM apparatus, offering superior advantages over printing heads in other WAAM apparatus using standard metal wires from welding wire (e.g., other printing heads). In practice, other printing heads do not have a protective tube 171; therefore, they only use a cylindrical protective ceramic gas cap, which may at best be similar to the protective gas cap 170 of the printing head 147. This cylindrical ceramic protective gas cap directs the gas flow from the printing head and prevents it from dispersing in board directions. However, this ceramic protective gas cap does not compress the arc column, enhance its stability, or reduce the adhesion of evaporated metal vapor from the melt pool to the tungsten electrode. Therefore, other printing heads cannot create a tiny melt pool, cannot print thin and ultra-thin parts, and cannot maintain arc stability at a low printing current like the novel printing head 147 of the present disclosure.

In some embodiments, the printing head 147 may be manufactured to very small dimensions. At the same time, the size of the wire spool 145 may be significantly reduced compared to wire spools in other WAAM apparatus. Along with aforementioned other advantages such as reducing the distance from the rollers to the wire feeding tube, reducing the length of the wire feeding tube from the wire feeder box to the printing head and the melt pool surface, and reducing the distance from the printing head to the surface of the printed product, the size of the parts and the overall size of the WAAM apparatus 100 of the present disclosure may be made very compact and portable, facilitating its use. This may also significantly reduce the cost of the equipment. The WAAM apparatus 100 may help produce printed parts with thin and ultra-thin walls, high surface accuracy, fast printing speed, and significantly reduced costs.

The above description and accompanying drawings only illustrate the disclosure's preferred embodiment. The disclosure is not necessarily limited to this preferred embodiment and can be modified and implemented in various ways. The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The enablements described above are considered novel over the prior art and are considered critical to the operation of at least one aspect of the disclosure and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

In the foregoing description and in the figures, like elements are identified with like reference numerals. The use of “e.g.,” “etc,” and “or” indicates non-exclusive alternatives without limitation, unless otherwise noted. The use of “including” or “includes” means “including, but not limited to,” or “includes, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

It should be noted that where a discrete value or range of values is set forth herein (e.g., 5, 6, 10, 100, etc.), it is noted that the value or range of values may be claimed more broadly than as a discrete number or range of numbers, unless indicated otherwise. Any discrete values mentioned herein are merely provided as examples.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A printing head for printing three-dimensional (3D) objects of metal materials, the printing head comprises:
a non-consumable tungsten electrode encased in a protective tube;
a cylindrical ceramic protective gas cap surrounding the protective tube and separated from the protective tube by a gap; and
a dual-layer inert gas supply, wherein:
the protective tube includes perforations along its body, and
the printing head has two layers of protective gas, wherein:
an outer protective gas flows through the gap between a cylindrical ceramic protective gas cap and the protective tube, and
an inner protective gas flows at high speed through the perforations along the body of the protective tube.

2. A metal 3D Wire Arc Additive Manufacturing (WAAM) printing apparatus comprising the printing head as defined in claim 1.

3. A metal wire feeder system for printing, comprising:
a wire spool assembly and a wire feeder box assembly, wherein:
the wire spool assembly includes a wire spool on which a metal wire is wound, and a first motor configured to unwind or rewind the metal wire from the wire spool,
the metal wire is directed through a guide tube to the wire feeder box assembly, the wire feeder box assembly includes a second motor and a wire feeder box, wherein:
the wire feeder box includes therein a drive roller and a driven roller configured to press the metal wire between them and to pull the wire forward,
a pressure adjustment mechanism configured to adjust a pressure between the drive roller and the driven roller,
a wire feeding tube passes through a wall of the wire feeder box to guide the metal wire out of the wire feeder box towards a melt pool,
the second motor configured to assist in pulling the metal wire by controlling the drive roller,
the drive roller has very small V-shaped grooves on its surfaces, and
the first motor and the second motor operate in synchronization.

4. The metal wire feeder system according to claim 3, further comprises a wire feeding nozzle attached to an exit end of the wire feeding tube, wherein an inner diameter of the wire feeding nozzle is 10% to 20% larger than a diameter of the metal wire, and the distance from the tip of wire feeding nozzle to the melt pool surface is less than 3 mm.

5. The wire feeder system according to claim 3, further comprises a controller for adjusting a pulling force of the metal wire, creating appropriate wire tension during a wire feeding process for printing.

6. The wire feeder system according to claim 4, further comprises a controller for adjusting a pulling force of the metal wire, creating appropriate wire tension during a wire feeding process for printing.

7. The wire feeder system according to claim 3, wherein the metal wire has a diameter from 0.1 to 0.6 mm.

8. The wire feeder system according to claim 4, wherein the metal wire has a diameter from 0.1 to 0.6 mm.

9. The wire feeder system according to claim 5, wherein the metal wire has a diameter from 0.1 to 0.6 mm.

10. The wire feeder system according to claim 6, wherein the metal wire has a diameter from 0.1 to 0.6 mm.

11. A metal 3D Wire Arc Additive Manufacturing (WAAM) printing apparatus comprising the wire feeder system according to claim 3.

12. A metal 3D WAAM printing apparatus comprising the wire feeder system according to claim 4.

13. A metal 3D WAAM printing apparatus comprising the wire feeder system according to claim 5.

14. A metal 3D WAAM printing apparatus comprising the wire feeder system according to claim 6.

15. A metal 3D WAAM printing apparatus comprising the wire feeder system according to claim 7.

16. A metal 3D WAAM printing apparatus comprising the wire feeder system according to claim 8.

17. A metal 3D WAAM printing apparatus comprising the wire feeder system according to claim 9.

18. The metal 3D WAAM printing apparatus according to claim 11, wherein the wire feeder box assembly of the wire feeder system is positioned close to the melt pool surface with the distance from the contact point of drive and driven rollers to the melt pool surface is less than 10 cm.

19. The metal 3D WAAM printing apparatus according to claim 11, wherein the WAAM printing apparatus includes a sealed enclosure defining a printing chamber; and
during a printing process, the printing chamber is filled with an inert gas environment, with the printing head, wire feeder system, and printed product contained within the printing chamber.

20. The metal 3D WAAM printing apparatus according to claim 18, wherein the WAAM printing apparatus includes a sealed enclosure defining a printing chamber; and
during a printing process, the printing chamber is filled with an inert gas environment, with the printing head, wire feeder system, and printed product contained within the printing chamber.
